(19) United States
(12) Patent Application Publication
(10) Pub. No.: US 2012/0268402 A1
(43) Pub. Date: Oct. 25, 2012

(54) TOUCH DISPLAY PANEL

(76) Inventors: Wen-Chun Wang, Taichung City (TW); Kuo-Chang Su, Tainan City (TW); Chin-Chang Liu, Taichung City (TW); Ming-Sin Jian, Taichung City (TW)

(21) Appl. No.: 13/451,506

(22) Filed: Apr. 19, 2012

(30) Foreign Application Priority Data
Apr. 20, 2011 (TW) 100113747

(51) Int. Cl. G06F 3/041; G09G 3/30

(52) U.S. Cl. 345/173; 345/76

(57) ABSTRACT

A touch display panel includes an electroluminescent display panel, a touch panel, and a patterned decoration layer. The electroluminescent display panel includes a plurality of display devices disposed in a display region, and at least one hot key display unit disposed in at least one hot key region. The touch panel is disposed oppositely to the electroluminescent display panel, and the touch panel includes a touch plate, a plurality of display region touch devices disposed on an inner surface of the touch plate facing the electroluminescent display panel and corresponding to the display region, and at least one hot key region touch device disposed on the inner surface of the touch plate and corresponding to the hot key region. The patterned decoration layer is disposed on the touch plate, and the patterned decoration layer has at least one transparent region corresponding to the hot key region.

### BACKGROUND OF THE INVENTION

1. Field of the Invention

The present invention relates to a touch display panel, and more particularly, to a touch display panel having touch hot key.

2. Description of the Prior Art

Touch panel, due to its human-machine interactive characteristic, has been widely used in electronic products such as smart phone, global positioning system (GPS), tablet PC, personal digital assistant (PDA) and laptop computer.

Please refer to FIG. 1. FIG. 1 is a schematic diagram illustrating a conventional touch smart phone. As shown in FIG. 1, the conventional smart phone 10 includes a display region 12 and a hot key 14. The display region 12 is able to provide both display and touch input functions, while the hot key 14 is a button with a default function such as a function of activating the display function of the display region 12 or a function of answering incoming calls. The hot key 14 of the conventional smart phone 10 is a mechanical button, and the frequency of pushing the hot key 14 is significantly high since the hot key 14 with the default function is the most commonly used button. Normally, the hot key 14 tends to be out of work after being pushed frequently. In addition, the hot key 14 of the conventional smart phone 10 can only display a predetermined hot key pattern, which cannot be modified when the default function is changed. Thus, the conventional smart phone 10 lacks a user-friendly interface.

### SUMMARY OF THE INVENTION

It is one objective of the present invention to provide a touch display panel using a touch device as a hot key to improve durability of the touch display panel.

It is another objective of the present invention to dispose a display device in the hot key region to provide a user-friendly interface.

According to a preferred embodiment of the present invention, a touch display panel is provided. The touch display panel has a display region and at least one hot key region. The touch display panel includes an electroluminescent display panel, a touch panel and a patterned decoration layer. The electroluminescent display panel includes a plurality of display devices disposed in the display region, and a hot key display unit disposed in the hot key region. The touch panel is disposed oppositely to the electroluminescent display panel, and the touch panel includes a touch plate, a plurality of display region touch devices disposed in the display region, and at least one hot key region touch device disposed in the hot key region. The display region touch devices and the hot key region touch device are disposed on an inner surface of the touch plate facing the electroluminescent display panel. The patterned decoration layer is disposed on the touch plate, and the patterned decoration layer has at least one transparent region corresponding to the hot key region.

According to another preferred embodiment of the present invention, a touch display panel is provided. The touch display panel has a display region and at least one hot key region. The touch display panel includes an electroluminescent display panel, a touch panel, a cover lens and a patterned decoration layer. The electroluminescent display panel includes a plurality of display devices disposed in the display region, and a hot key display unit disposed in the hot key region. The touch panel is disposed oppositely to the electroluminescent display panel, and the touch panel includes a touch wire plate, a plurality of display region touch devices disposed on the touch wire plate and in the display region, and at least one hot key region touch device disposed on the touch wire plate and in the hot key region. The cover lens is disposed on a side of the touch panel opposite to the electroluminescent display panel. The patterned decoration layer is disposed on a surface of the cover lens facing the touch panel, and the patterned decoration layer has at least one transparent region corresponding to the hot key region.

The touch display panel of the present invention uses a touch device as a hot key, instead of a conventional mechanical button, and thus the durability of the hot key can be improved.

The touch display panel of the present invention disposes a display device in the hot key region, and the user can define the hot key pattern. Thus, a user-friendly interface can be provided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional touch smart phone.

FIG. 2A is a schematic cross-sectional view of a touch display panel according to a first preferred embodiment of the present invention.

FIG. 2B schematically illustrates a cross-sectional view of the touch display panel according to a variant embodiment of the first preferred embodiment shown in FIG. 2A.

FIG. 2C schematically illustrates a cross-sectional view of the touch display panel according to another variant embodiment of the first preferred embodiment shown in FIG. 2A.

FIG. 3 is a cross-sectional view schematically illustrating a touch display panel according to a second preferred embodiment of the present invention.

FIG. 4A is a cross-sectional view schematically illustrating a touch display panel according to a third preferred embodiment of the present invention.

FIG. 4B schematically illustrates a cross-sectional view of the touch display panel according to a first variant embodiment of the third preferred embodiment shown in FIG. 4A.

FIG. 4C schematically illustrates a cross-sectional view of the touch display panel according to a second variant embodiment of the third preferred embodiment shown in FIG. 4A.

FIG. 4D schematically illustrates a cross-sectional view of the touch display panel according to a third variant embodiment of the third preferred embodiment shown in FIG. 4A.

FIG. 4E schematically illustrates a cross-sectional view of the touch display panel according to a fourth variant embodiment of the third preferred embodiment shown in FIG. 4A.

FIG. 5A is a schematic diagram illustrating the electroluminescent display panel of the touch display panel.

FIG. 5B is a top view of the touch panel of the touch display panel.

FIG. 5C is a bottom view of the touch panel of the touch display panel.

FIG. 6A is a schematic diagram illustrating the electroluminescent display panel of the touch display panel.

FIG. 6B is a top view of the touch display panel of FIG. 6A.

FIG. 7 is a schematic diagram illustrating the touch panel of the touch display panel according to still another embodiment of the present invention.

FIG. 8A is a top view illustrating the touch device of the touch display panel according to a preferred embodiment of the present invention.

FIG. 8B is a cross-section view of the touch device of the touch display panel taken along line A-A′ of FIG. 8A.

FIG. 9-FIG. 11 are schematic diagrams respectively illustrating the touch device of the touch display panel according to three different variant embodiments of FIG. 8A and FIG. 8B.

FIG. 12A is a top view illustrating the touch device of the touch display panel according to another preferred embodiment of the present invention.

FIG. 12B is a cross-section view of the touch device of the touch display panel taken along line A-A′ of FIG. 12A.

FIG. 13 is a schematic diagram illustrating the touch device of the touch display panel according to a variant embodiment of FIG. 12A and FIG. 12B.

FIG. 14A is a schematic diagram illustrating a single-layered sensing electrode according to a preferred embodiment of the present invention.

FIG. 14B is a schematic diagram illustrating a single-layered sensing electrode according to a variant embodiment of the preferred embodiment of the present invention shown in FIG. 14A.

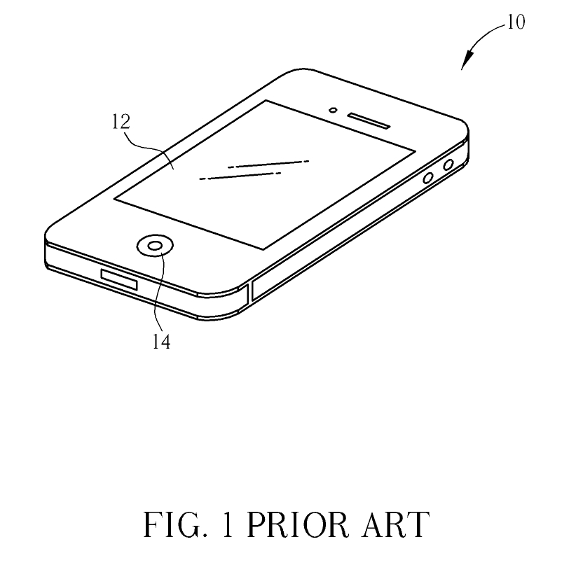

### DETAILED DESCRIPTION

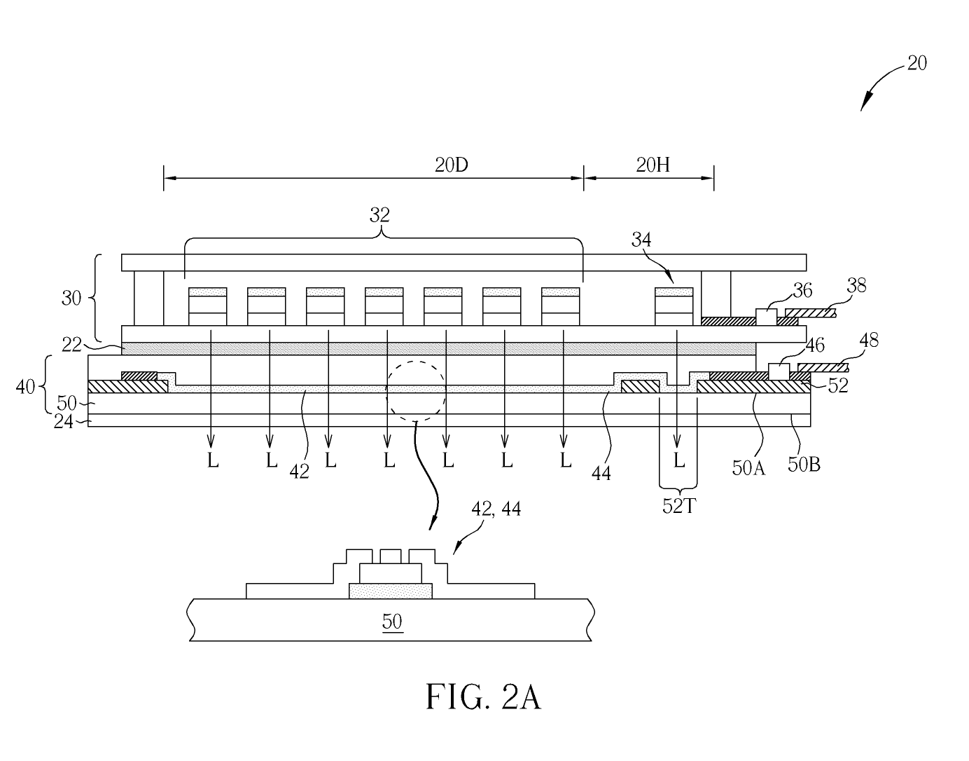

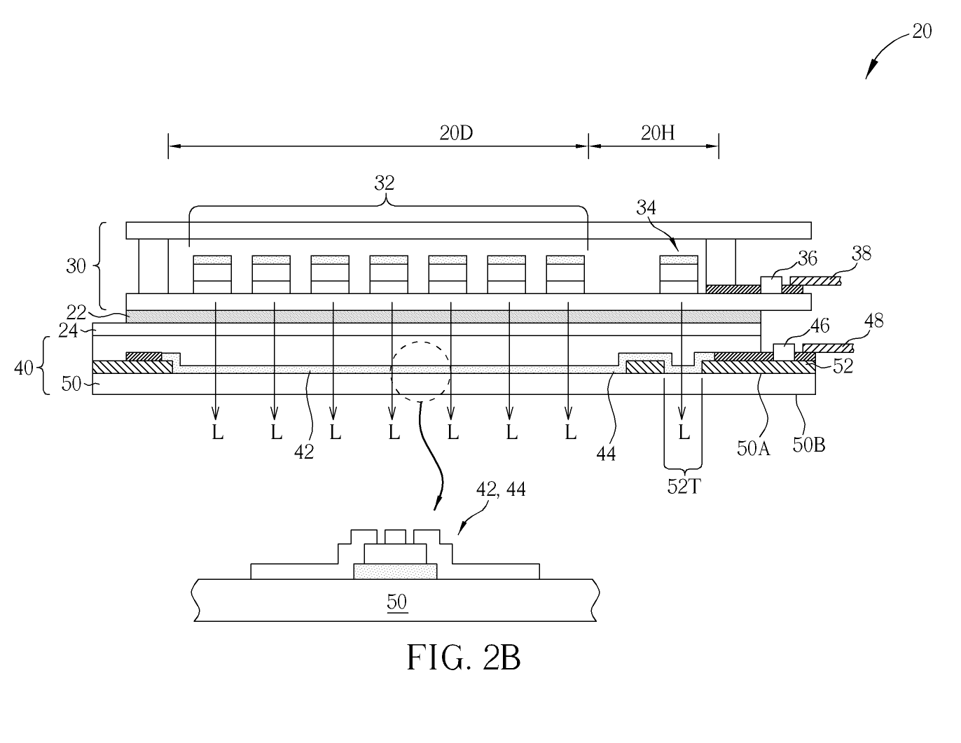

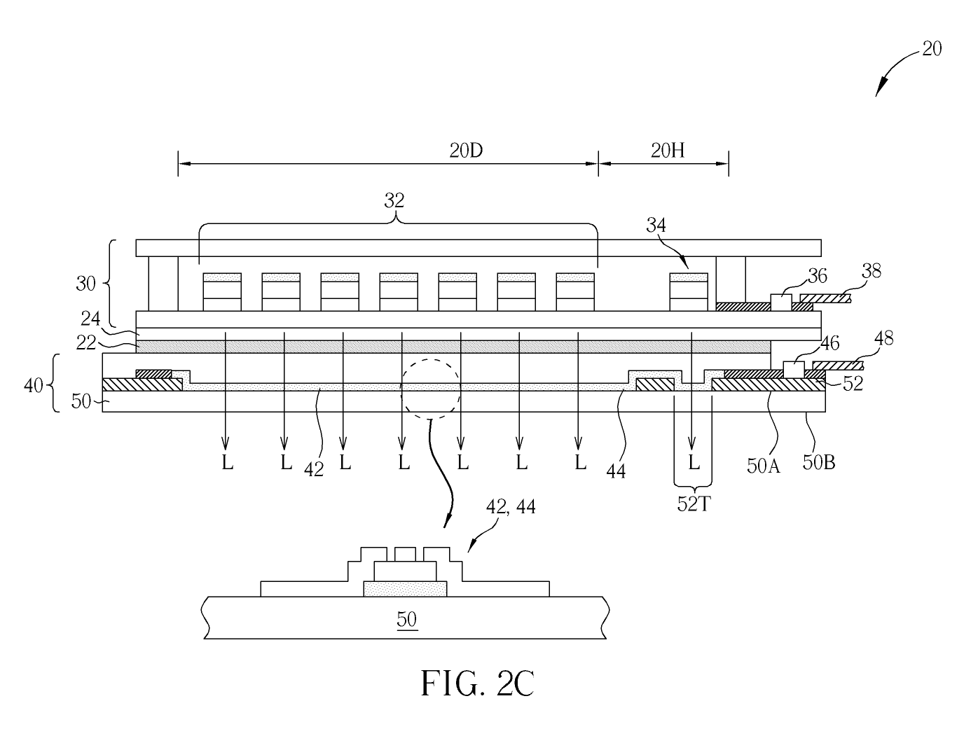

Please refer to FIG. 2A. FIG. 2A is a schematic cross-sectional view of a touch display panel according to a first preferred embodiment of the present invention. As shown in FIG. 2A, the touch display panel 20 of this embodiment includes a display region 20D and at least one hot key region 20H. The display region 20D is for displaying images, while the hot key region 20H is for disposition of a hot key with a default function. In this embodiment, the touch display panel 20 mainly includes an electroluminescent display panel 30, a touch panel 40 and a patterned decoration layer 52. The electroluminescent display panel 30 includes a plurality of display devices 32 arranged in an array in the display region 20D, and at least one hot key display unit 34 disposed in the hot key region 20H. In this embodiment, the electroluminescent display panel 30 may be an organic light emitting diode (OLED) display panel, and thus the display devices 32 include a plurality of organic light emitting diode devices arranged in an array. The display devices 32 may be an active matrix organic light emitting diode (AMOLED) or a passive matrix organic light emitting diode (PMOLED). Also, the hot key display unit 34 may include at least one light emitting device for generating light in the hot key region 20H, or a light emitting array for displaying changeable hot key pattern with single color or full color. The light emitting device or the light emitting array of the hot key display unit 34 can be formed simultaneously with the display devices 32, which means both the hot key display unit 34 and the display devices 32 can be OLED devices. Consequently, it is more convenient for the user to be aware of the default function of the hot key when operating the touch display panel 20 or any electronic product equipped with the touch display panel 20.

The touch panel 40 and the electroluminescent display panel 30 are disposed oppositely, and an adhesive layer 22 may be used to bond the touch panel 40 to the electroluminescent display panel 30. The adhesive layer 22 may be a pressure sensitive adhesive (PSA), a liquid clear optical adhesive (LOCA), or any suitable adhesive. The adhesive layer 22 may be an entire film disposed thoroughly between the touch panel 40 and the electroluminescent display panel 30, or may be disposed only in the periphery of the touch panel 40 and the electroluminescent display panel 30. In addition, a shielding layer (not shown) can be selectively disposed between the touch panel 40 and the electroluminescent display panel 30 in order to avoid signal interference. The shielding layer may be a full transparent electrode, or a meshed transparent electrode. The touch panel 40 includes a touch plate 50, a plurality of display region touch devices 42 disposed in the display region 20D for realizing touch input function in the display region 20D, and at least one hot key region touch device 44 disposed in the hot key region 20H as a hot key able to be operated in a touch control manner. The display region touch devices 42 and the hot key region touch device 44 can be any types of touch devices. In all of the embodiments of the present invention, the display region touch devices 42 can be made of one patterned electrode layer including a plurality of sensing pads (single-layered sensing electrode), or be made of two or more patterned electrode layers including a plurality of sensing pads (multi-layered sensing electrode). The display region touch devices 42 are not limited to be disposed on the inner surface 50A of the touch plate 50 facing the electroluminescent display panel 30. For example, when the display region touch devices 42 include single-layered sensing electrodes, the single-layered sensing electrodes can be disposed on the outer surface 50B of the touch plate 50; when the display region touch devices 42 include double-layered sensing electrodes, one layer of the double-layered sensing electrodes can be disposed on the inner surface 50A of the touch plate 50, and the other layer of the double-layered sensing electrodes can be disposed on the outer surface 50B of the touch plate 50. In this embodiment, the touch panel 40 is a capacitive touch panel, but not limited thereto. For example, the touch panel 40 may also be resistive touch panel, optical touch panel, electro-magnetic touch panel, etc. The touch plate 50 is for disposing the display region touch devices 42, the hot key region touch device 44 and the patterned decoration layer 52, and also for protecting the display region touch devices 42 and the hot key region touch device 44. In addition, the user can implement touch input through the touch plate 50. In this embodiment, the touch plate 50 may serve as a cover lens, which is substantially a substrate. The substrate may be a glass substrate e.g. a strengthened glass substrate, or a transparent plastic substrate, but not limited thereto. In this embodiment, the display region touch devices 42 and the hot key region touch device 44 are disposed on an inner surface 50A of the touch plate 50 facing the electroluminescent display panel 30. The patterned decoration layer 52 is substantially corresponding to the periphery of the touch plate 50. The main function of the patterned decoration layer 52 is to shield the wires disposed in the periphery of the touch panel 40 so that the wires are invisible for the user. The material of the patterned decoration layer 52 may be, for instance, ink, diamond-like carbon, metal, ceramics, photoresist or resin. The material of the patterned decoration layer 52 may also be any suitable organic material or inorganic material having light-shielding property. Also, the patterned decoration layer 52 may be a single-layered structure, or a multi-layered structure. The patterned decoration layer 52 is disposed on the inner surface 50A of the touch plate 50, but not limited thereto. For example, the patterned decoration layer 52 may also be disposed on the outer surface 50B of the touch plate 50. The patterned decoration layer 52 has at least one transparent region 52T corresponding to the hot key region 20H. The transparent region 52T may be, for instance, a window, a transparent pattern or a region formed by a transparent material, such that user can see the hot key pattern displayed by the hot key display unit 34 through the transparent region 52T, and implement touch input upon the hot key region touch device 44 in the transparent region 52T. For example, when the hot key display unit 34 is a light emitting array able to display a changeable hot key pattern, the transparent region 52T may be a window or a region formed by a transparent material that allows light to pass through; when the hot key display unit 34 is a light emitting device able to emit light, the transparent region 52T may be a transparent pattern such that the light passing through the transparent pattern can display a hot key pattern. In addition, in this embodiment, part of the hot key region touch devices 44 may be disposed on the patterned decoration layer 52, but not limited thereto. For example, part of the hot key region touch devices 44 may be disposed under the patterned decoration layer 52. Also, the display region touch devices 42 can partially overlap the inner edge of the patterned decoration layer 52 in a vertical projection direction for enabling touch input function in the perimeter of the display region 20D. Also, in order to improve display quality, the touch display panel 20 may further include an optical film 24 with specific function. For instance, the optical film 20 may be a polarizing film, anti-reflection film, anti-glare film, protection film, etc. In this embodiment, the optical film 24 is disposed on the outer surface 50B of the touch plate 50. Particularly, the optical film 24 is preferably disposed on the outer surface 50B of the touch plate 50 when the adhesive layer 22 is disposed only in the periphery of the touch panel 40 and the electroluminescent display panel 30, but not limited thereto. The electroluminescent display panel 30 may be driven by a driving chip 36, and the driving chip 36 may be electrically connected to a flexible printed circuit board 38 to create an external electrical connection. The touch panel 40 may be electrically connected to a flexible printed circuit board 48 to create an external electrical connection, but not limited thereto. For example, the electroluminescent display panel 30 and the touch panel 40 may share the same driving chip, and the driving chip may be a chip on glass (COG) formed on the electroluminescent display panel 30, or on the touch panel 40, or on the flexible printed circuit board, or on a printed circuit board (PCB) (not shown).

The touch display panel 20 of this embodiment uses the hot key region touch device 44 as a hot key, instead of conventional mechanical button. The reliability and durability of the touch display panel 20 are therefore improved since the mechanical hot key button is omitted. In addition, the hot key region touch device 44 and the display region touch devices 42 may be formed integrally without requiring extra process steps, and thus the manufacturing cost is reduced. Furthermore, the touch display panel 20 includes the hot key display unit 34 in the hot key region 20H, which can display a predetermined hot key pattern or changeable hot key patterns through the transparent region 52T of the patterned decoration layer 52. Consequently, the touch display panel 20 possesses a more friendly operation interface.

Please refer to FIG. 2B and FIG. 2C. FIG. 2B schematically illustrates a cross-sectional view of the touch display panel according to a variant embodiment of the first preferred embodiment shown in FIG. 2A, and FIG. 2C schematically illustrates a cross-sectional view of the touch display panel according to another variant embodiment of the first preferred embodiment shown in FIG. 2A. As shown in FIG. 2B, in this variant embodiment, the optical film 24 is formed between the adhesive layer 22 and the touch panel 40. As shown in FIG. 2C, in this variant embodiment, the optical film 24 is formed between the adhesive layer 22 and the electroluminescent display panel 30.

In this embodiment, the touch panel 40 is formed on the touch plate (cover lens) 50 in advance, and then bonded to the electroluminescent display panel 30 with the adhesive layer 22. Therefore, the manufacturing cost and thickness can be reduced because one piece of substrate is omitted. Alternatively, the touch panel 40 and the electroluminescent display panel 30 can be formed separately, and bonded together subsequently. Also, in this embodiment, the electroluminescent display panel 30 is a bottom emission organic light emitting diode display panel. Thus, the touch panel 40 is disposed under the electroluminescent display panel 30, and the light L emitted by the electroluminescent display panel 30 would pass through the touch panel 40 so that user can see the images. The electroluminescent display panel 30 is not limited to be a bottom emission organic light emitting diode display panel, and can be a top emission organic light emitting diode display panel.

The touch display panel of the present invention is not limited to the aforementioned embodiment. The touch display panel of other embodiments will be detailed. To simplify the description, the identical components in each of the following embodiments are marked with identical symbols. For making it easier to compare the difference between the embodiments, the following description will detail the dissimilarities among different embodiments and the identical features will not be redundantly described.

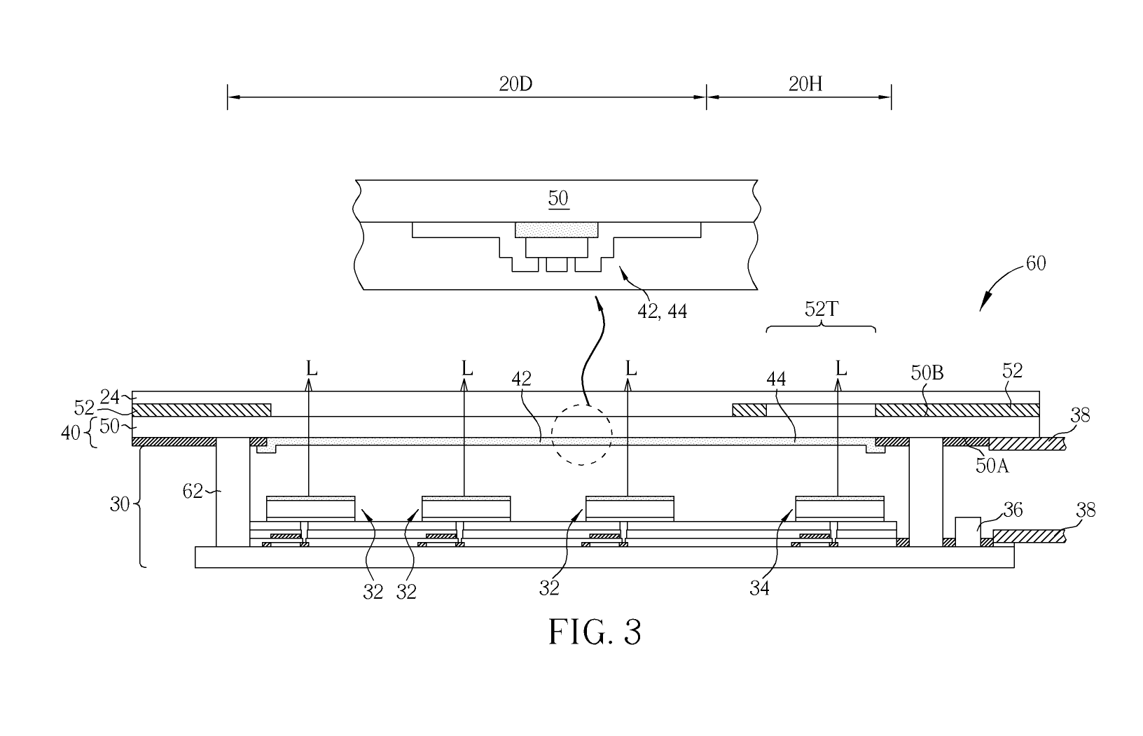

Please refer to FIG. 3. FIG. 3 is a cross-sectional view schematically illustrating a touch display panel according to a second preferred embodiment of the present invention. As shown in FIG. 3, different from the above embodiment, the touch plate 50 is served as a lid encapsulation of the electroluminescent display panel 30, and can be directly bonded to the electroluminescent display panel 30 with a sealant 62. Accordingly, two pieces of substrates are omitted. The lid encapsulation may be a glass substrate or a transparent plastic substrate, but not limited thereto. In this embodiment, the electroluminescent display panel 30 is a top emission electroluminescent display panel, and therefore the touch panel 40 is disposed on the electroluminescent display panel 30. The light L emitted by the electroluminescent display panel 30 will pass through the touch panel 40 so that user can see the images. The patterned decoration layer 52 is disposed on the outer surface 50B of the touch plate 50. The touch display panel 60 of this embodiment further includes an optical film 24, disposed on the surface of the patterned decoration layer 52 facing the user, but not limited thereto. Furthermore, the touch display panel 60 of this embodiment may further include a driving chip 36 disposed on the electroluminescent display panel 30, and the driving chip 36 may be directly or indirectly electrically connected to the touch panel 40 through a flexible printed circuit board 38. The driving chip 36 may drive both the electroluminescent display panel 30 and the touch panel 40, but not limited thereto. For example, the electroluminescent display panel 30 and the touch panel 40 may be driven separately by different driving chips. Similarly, in this embodiment, the patterned decoration layer 52 has at least one transparent region 52T corresponding to the hot key region 20H, and exposing the hot key display unit 34 and the hot key region touch device 44. The transparent region 52T may be, for instance, a window, a transparent pattern or a region formed by a transparent material.

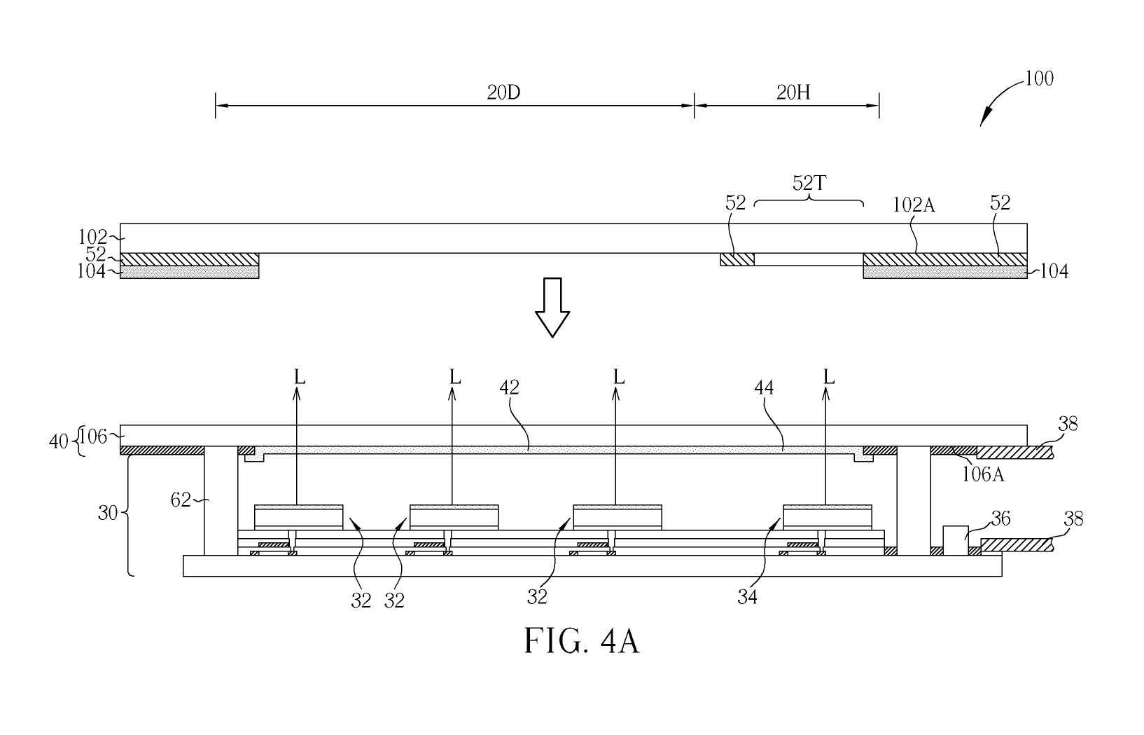

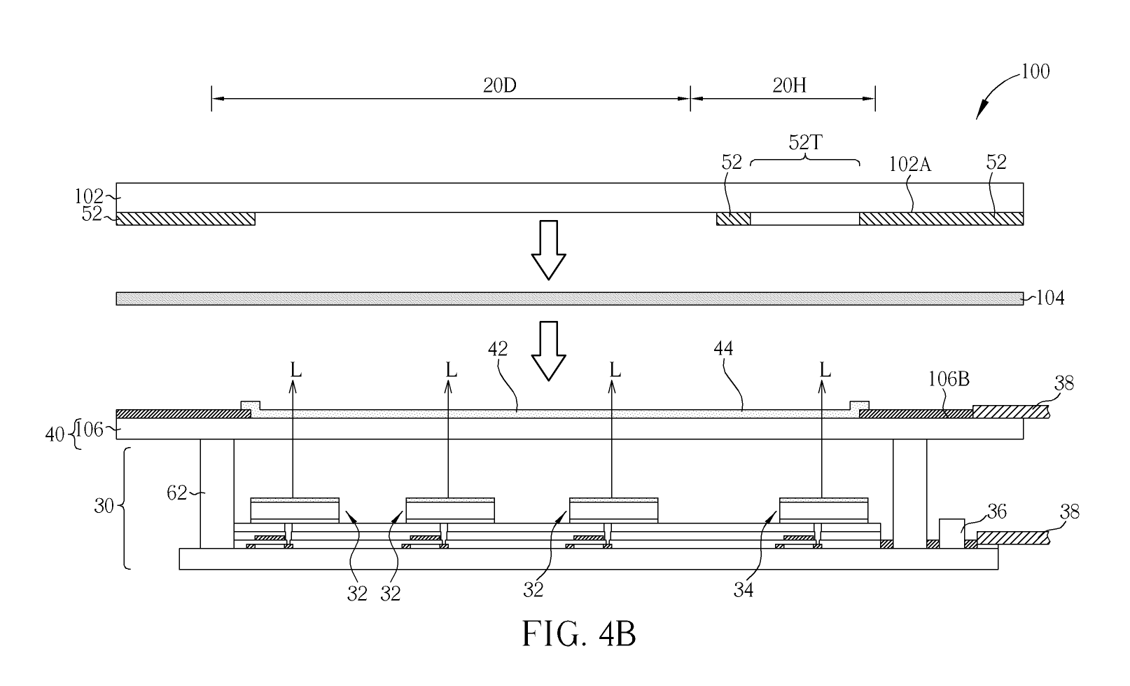

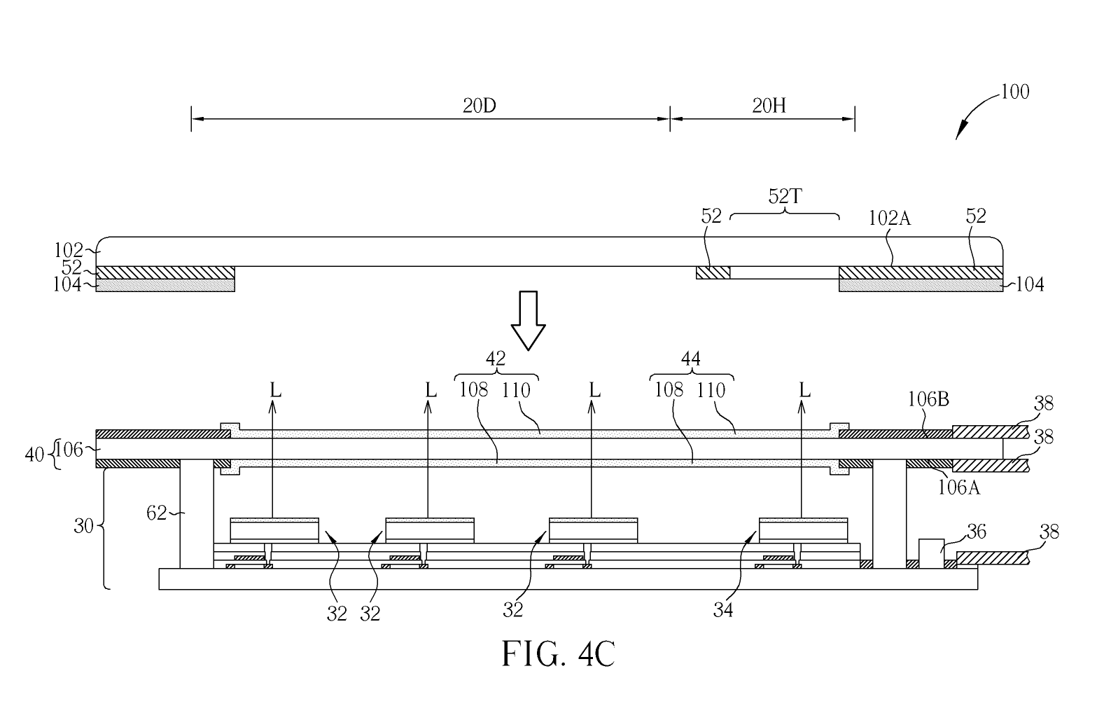

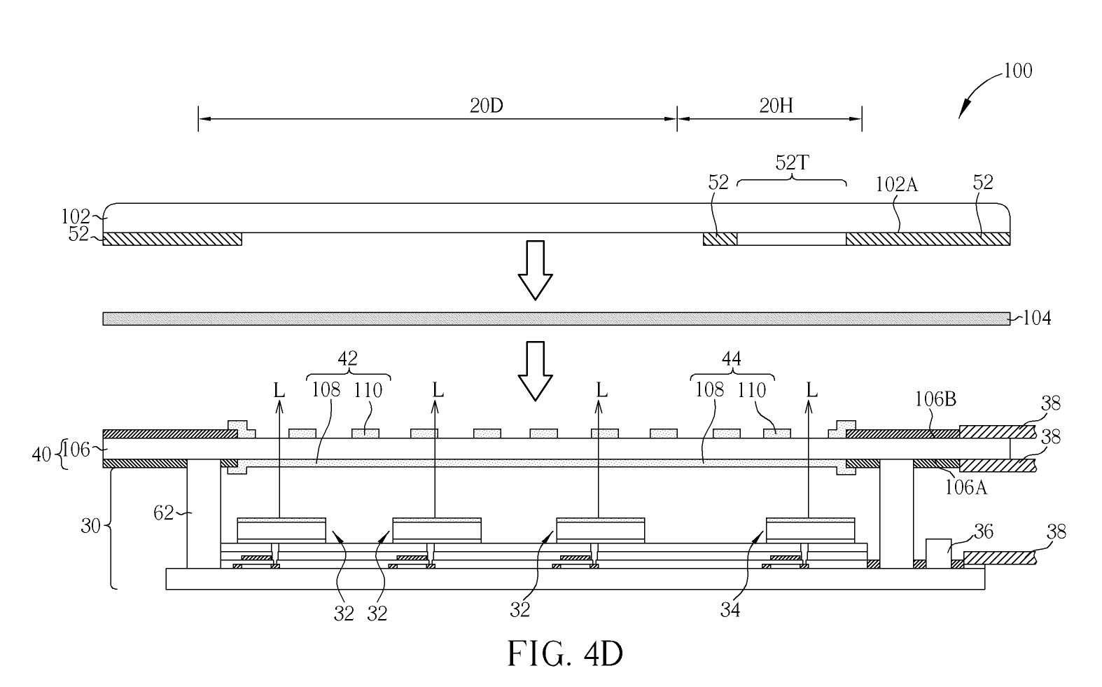

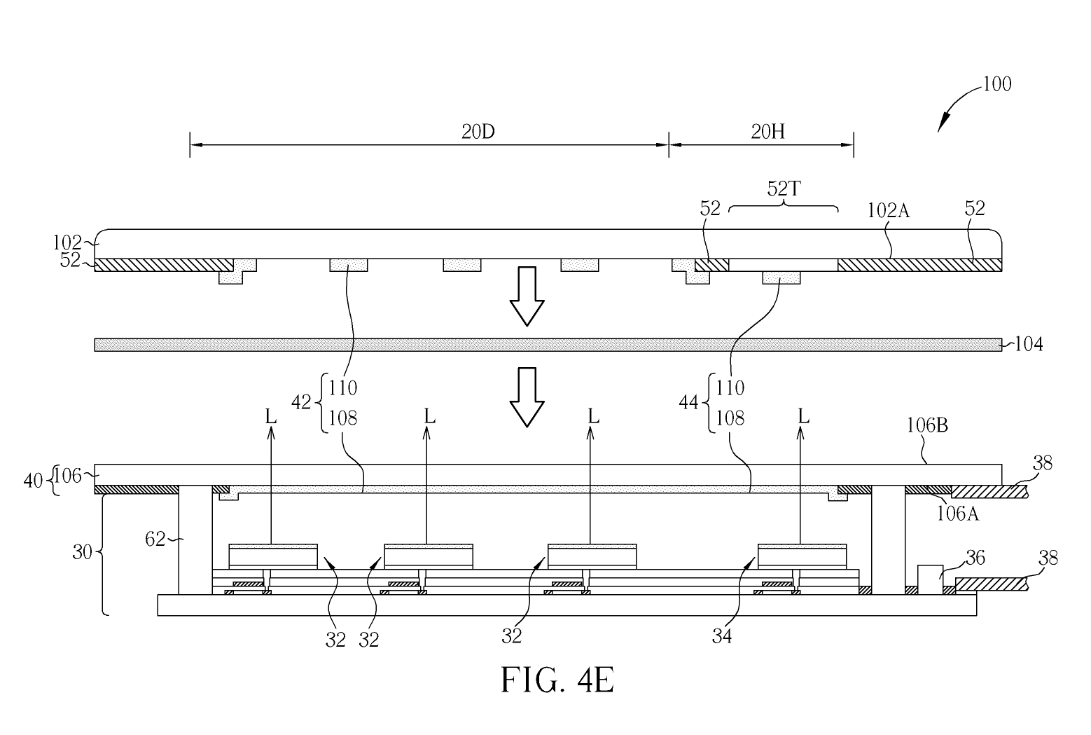

Please refer to FIG. 4A. FIG. 4A is a cross-sectional view schematically illustrating a touch display panel according to a third preferred embodiment of the present invention. As shown in FIG. 4A, different from the embodiment of FIG. 3, the touch display panel 100 of this embodiment further includes a lid encapsulation 102 disposed on the other side of the touch panel 40 opposite to the electroluminescent display panel 30. The patterned decoration layer 52 is disposed on a surface 102A of the lid encapsulation 102 facing the touch panel 40. The user can implement touch input through the lid encapsulation 102. The material of the lid encapsulation 102 may be glass e.g. strengthened glass to enhance durability, but not limited thereto. For instance, the material of the lid encapsulation 102 may also be plastic. The lid encapsulation 102 may be bonded to the touch panel 40 with an adhesive layer 104. The adhesive layer 104 may be disposed only on the surface of the patterned decoration layer 52, but not limited thereto. For instance, the adhesive layer 104 may be an entire film as shown in FIGS. 4B, 4D and 4E. The adhesive layer 104 may be a solid optical adhesive such as a pressure sensitive adhesive, or liquid clear optical adhesive. Also, in this embodiment, the display region touch devices 42 and the hot key region touch device 44 are disposed on a surface 106A of the touch wire plate 106 of the touch panel 40 facing the electroluminescent display panel 30.

Please refer to FIG. 4B. FIG. 4B schematically illustrates a cross-sectional view of the touch display panel according to a first variant embodiment of the third preferred embodiment shown in FIG. 4A. As shown in FIG. 4B, different from the embodiment of FIG. 4A, in this variant embodiment, the display region touch devices 42 and the hot key region touch device 44 are disposed on a surface 106B of the touch wire plate 106 of the touch panel 40 facing the lid encapsulation 102. In addition, the adhesive layer 104 may be an entire film, but not limited thereto.

Please refer to FIG. 4C. FIG. 4C schematically illustrates a cross-sectional view of the touch display panel according to a second variant embodiment of the third preferred embodiment shown in FIG. 4A. Different from the embodiment of FIG. 4A, in this variant embodiment, as shown in FIG. 4C, the first sensing electrode 108 and the second sensing electrode 110 are disposed on the surface 106A and the surface 106B, respectively, of the touch wire plate 106. It is appreciated that both the first sensing electrode 108 and the second sensing electrode 110 are patterned electrodes. For example, the first sensing electrode 108 includes a plurality of X pads, and the second sensing electrode 110 includes a plurality of Y pads. In addition, the edge of the lid encapsulation 102 may be filleted or chamfered. On the other hand, in the embodiments of FIG. 4A and FIG. 4B, the patterned first sensing electrode (not shown) and the patterned second sensing electrode (not shown) are disposed on the same surface of the touch wire plate 106.

Please refer to FIG. 4D. FIG. 4D schematically illustrates a cross-sectional view of the touch display panel according to a third variant embodiment of the third preferred embodiment shown in FIG. 4A. In this variant embodiment, the pattern of the second sensing electrode 110 disposed on the surface 106B of the touch wire plate 106 is clearly shown in FIG. 4D, and the pattern of the first sensing electrode 108 disposed on the surface 106A of the touch wire plate 106 is not shown due to the position of the cross-sectional line of FIG. 4D.

Please refer to FIG. 4E. FIG. 4E schematically illustrates a cross-sectional view of the touch display panel according to a fourth variant embodiment of the third preferred embodiment shown in FIG. 4A. As shown in FIG. 4E, in this variant embodiment, the first sensing electrode 108 is disposed on the surface 106A of the touch wire plate 106, and the first sensing electrode 108 is patterned, which cannot be shown due to the position of the cross-sectional line of FIG. 4E. The second sensing electrode 110 is disposed on the surface 102A of the lid encapsulation 102 facing the touch panel 40, and the pattern of the second sensing electrode 110 is clearly shown in FIG. 4E.

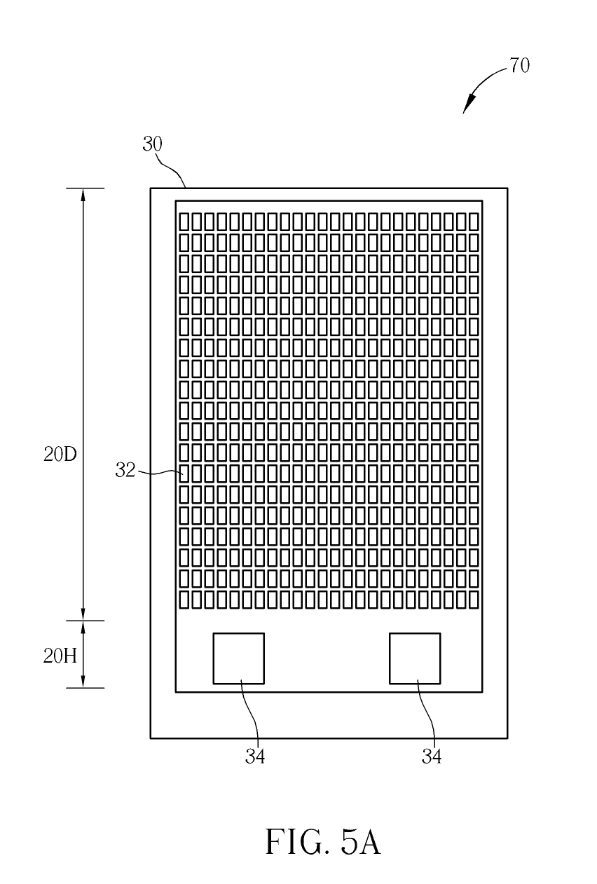

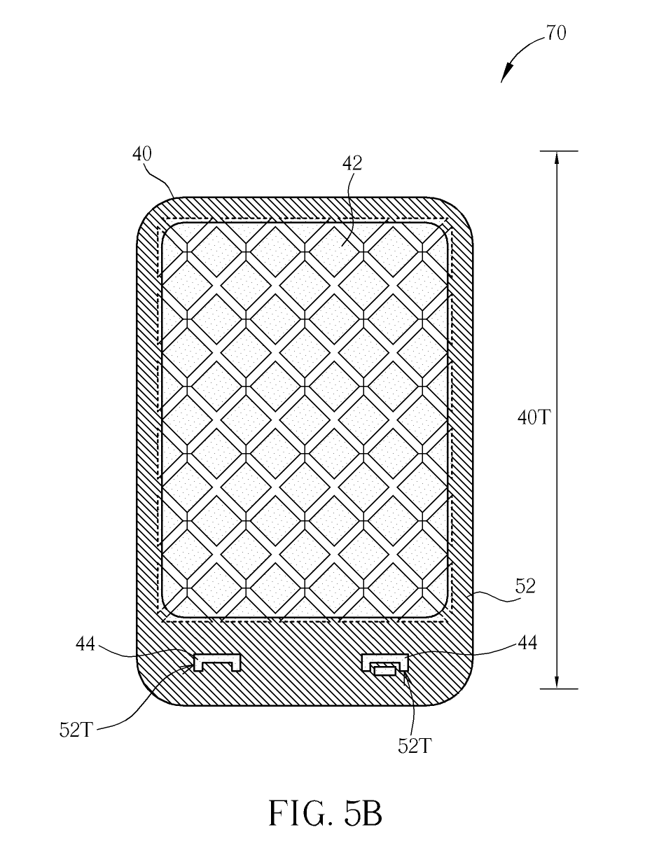

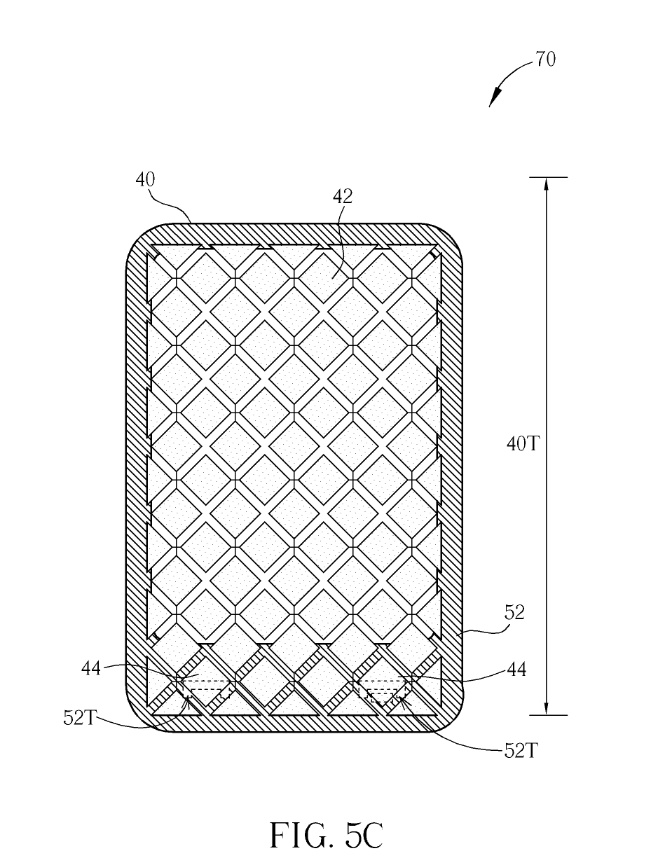

Please refer to FIG. 5A, FIG. 5B and FIG. 5C, as well as FIG. 2A, FIG. 2B, FIG. 2C, FIG. 3, FIG. 4A, FIG. 4B, FIG. 4C, FIG. 4D and FIG. 4E. FIG. 5A, FIG. 5B and FIG. 5C illustrate a touch display panel according to a preferred embodiment of the present invention, where FIG. 5A is a schematic diagram illustrating the electroluminescent display panel of the touch display panel, FIG. 5B is a top view of the touch panel of the touch display panel, and FIG. 5C is a bottom view of the touch panel of the touch display panel. The cross-sectional structure of the touch display panel of this embodiment may be any one of the touch display panel of the aforementioned embodiments or variant embodiments, and is not redundantly described. As shown in FIG. 5A, FIG. 5B and FIG. 5C, the electroluminescent display panel 30 of the touch display panel 70 includes a display region 20D and at least one hot key region 20H. In this embodiment, two hot key regions 20H are used as an example, but not limited thereto. The electroluminescent display panel 30 may includes a plurality of display devices 32 arranged in an array in the display region 20D for displaying images, and hot key display units 34 disposed in the hot key region 20H for displaying hot key pattern. In this embodiment, each hot key display unit 34 is a light emitting device able to emit light. The transparent region 52T of the patterned decoration layer 52 of FIG. 5B is a transparent pattern. The touch panel 40 includes a plurality of display region touch devices 42 corresponding to the display region 20D for providing touch input function, and at least one hot key region touch device 44 corresponding to the hot key region 20H as a hot key so that the user can execute the function of the hot key in a touch input manner. The transparent region 52T of the patterned decoration layer 52 is corresponding to the hot key display unit 34 and at least part of the hot key region touch device 44 of the hot key region 20H, and thus the user can see the hot key pattern displayed by the hot key display unit 34 and execute touch input. For example, when the touch display panel is applied in a mobile phone, two hot key display units 34 can emit light, and respectively display one hot key pattern showing connecting/answering function and another hot key pattern showing disconnecting function through the transparent pattern of the transparent region 52T. When the touch display panel is applied in a GPS, two hot key display units 34 can emit light, and respectively display one hot key pattern showing zoom-in function and another hot key pattern showing zoom-out function through the transparent pattern of the transparent region 52T. In addition, the touch panel 40 has a touch region 40T corresponding to the display region 20D and the hot key region 20H. The display region touch devices 42 are arranged in an array corresponding to the display region 20D, and the hot key region touch devices 44 are corresponding to the hot key regions 20H. Preferably, the sensing electrodes of the display region touch devices 42 partially overlaps the inner edge of the patterned decoration layer 52 in a vertical projection direction for enabling touch input function in the perimeter of the display region 20D. The transparent pattern of the transparent region 52T may be modified based on different requirement, but not limited to the aforementioned patterns.

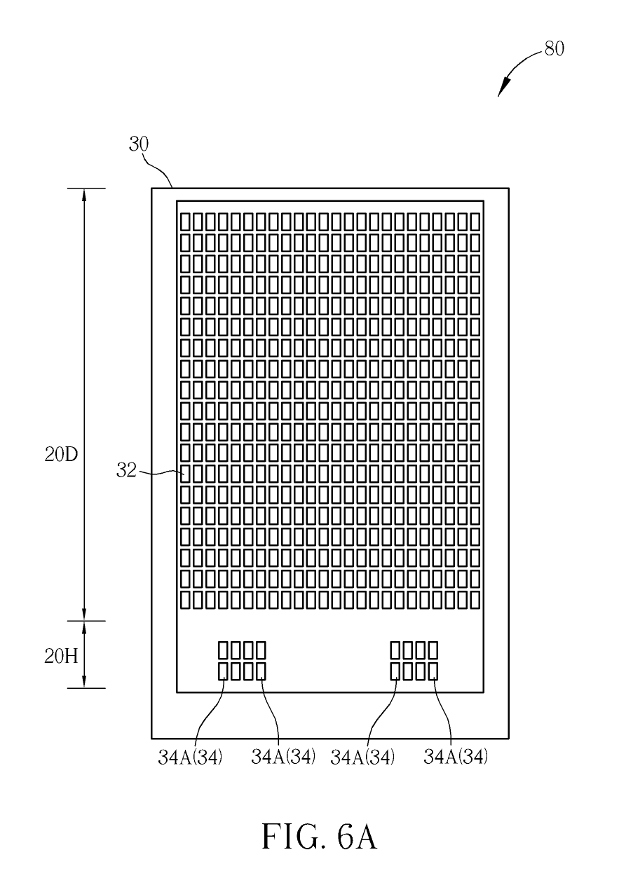

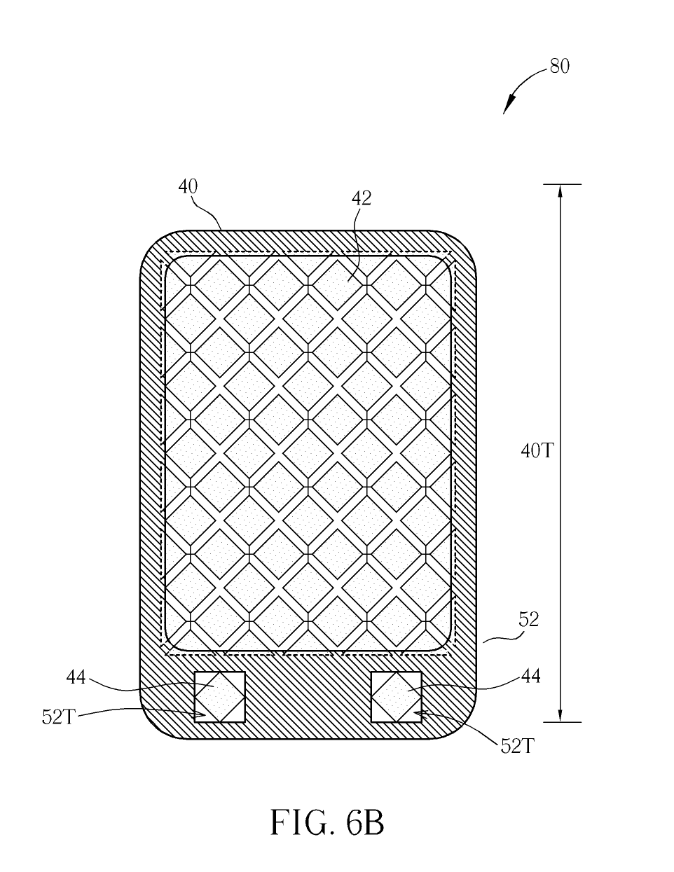

Please refer to FIG. 6A and FIG. 6B, as well as FIG. 2A, FIG. 2B, FIG. 2C, FIG. 3, FIG. 4A, FIG. 4B, FIG. 4C, FIG. 4D and FIG. 4E. FIG. 6A and FIG. 6B illustrate the electroluminescent display panel of the touch display panel according to another embodiment of the present invention, where FIG. 6A is a schematic diagram illustrating the electroluminescent display panel of the touch display panel, and FIG. 6B is a top view of the touch display panel. As shown in FIG. 6A and FIG. 6B, different from the aforementioned embodiments, each of the hot key display units 34 of the touch display panel 80 of this embodiment is a light emitting array. Each light emitting array includes a plurality of light emitting devices 34A able to emitting light of the same color or different colors arranged in an array. Consequently, the light emitting array can display changeable single-color or full-color hot key pattern. In addition, the transparent region 52T of the patterned decoration layer 52 of FIG. 6B is a window. For instance, when the touch display panel 80 is applied in a smart phone, in a phone mode, two hot key display units 34 can display one hot key pattern showing connecting/answering function and another hot key pattern showing disconnecting function, respectively, and thus the user can see the hot key patterns through the window of the transparent region 52T. When the smart phone is in a GPS mode, two hot key display units 34 can display one hot key pattern showing zoom-in function and another hot key pattern showing zoom-out function, respectively, and thus the user can see the hot key patterns through the window of the transparent region 52T. Since the window of the transparent region 52T is corresponding to at least part of the hot key region touch devices 44, the touch input function can be executed in the window of the transparent region 52T. In other words, the window of the transparent region 52T allows the user to see different hot key patterns displayed by the light emitting array based on different operation modes, and allows the user to execute the touch function. This is a humanity-oriented and practical design, because no display region has to be split for displaying the hot key pattern. Consequently, without requiring displaying the hot key pattern in the display region, the area of the display region can be all used to display desired image when operating the hot key.

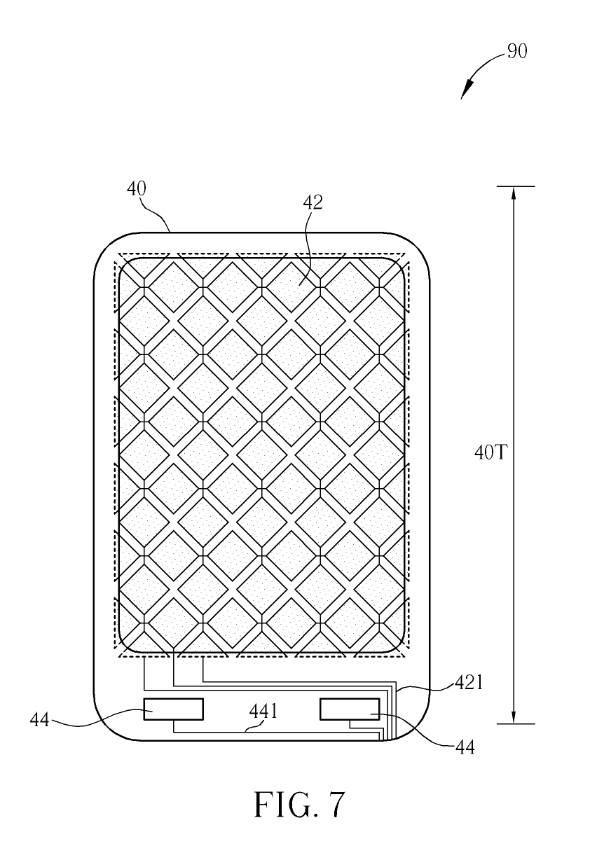

Please refer to FIG. 7. FIG. 7 is a schematic diagram illustrating the touch panel of the touch display panel according to still another embodiment of the present invention. It is appreciated that the patterned decoration layer is omitted for showing the hot key display unit and its wiring. As shown in FIG. 7, the signal line 421 of the display region touch device 42 and the signal line 441 of the hot key region touch device 44 of the touch display panel 90 of this embodiment are conducting lines electrically disconnected from each other. In other words, the display region touch device 42 and the hot key region touch device 44 can be driven independently. Under some modes, like a stand-by mode, the hot key region touch device 44 can be turned on, while the display region touch device 42 can be turned off for saving power consumption. The display region touch device 42 and the hot key region touch device 44 can also share the same driving chip and flexible printed circuit board. Also, for facilitate layout of the signal lines, the electrode pattern of the hot key region touch device 44 may be rectangle, but not limited thereto. In addition, the electrical connection between the driving and the display region touch device 42 and/or the hot key region touch device 44 is not limited to be created through the flexible printed circuit board. For example, the driving chip can be a chip on glass.

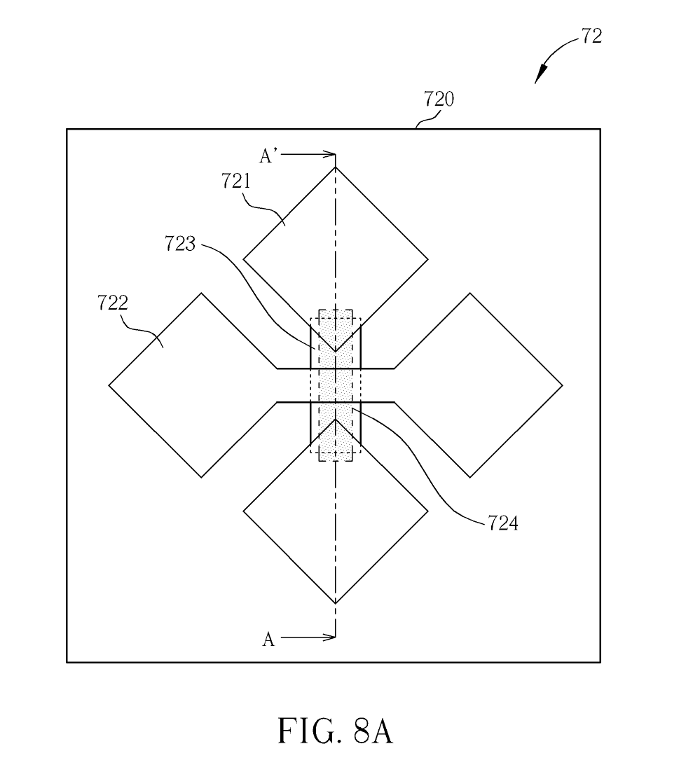

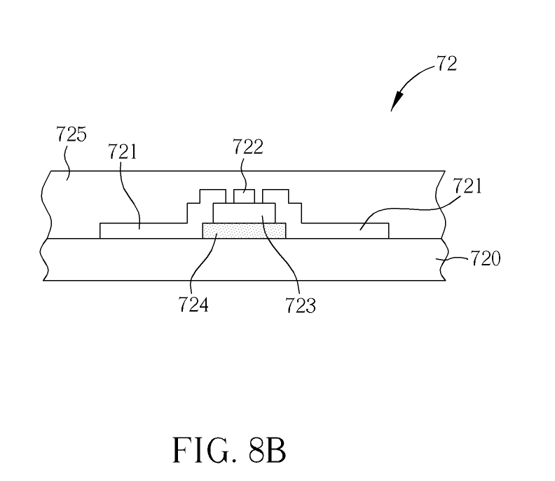

Please refer to FIG. 8A and FIG. 8B. FIG. 8A is a top view illustrating the touch device of the touch display panel according to a preferred embodiment of the present invention, and FIG. 8B is a cross-section view of the touch device of the touch display panel taken along line A-A′ of FIG. 8A. As shown in FIG. 8A and FIG. 8B, in this embodiment, the display region touch device or the hot key region touch device can be, for example, a capacitive touch device 72, which includes a substrate 720, a bridge line 724, an insulating layer 723, a plurality of first sensing electrodes 721 and a plurality of second sensing electrodes 722. The bridge line 724 is disposed on the substrate 720; the insulating layer 723 covers the bridge line 724, and exposes two terminals of the bridge line 724 and part of the substrate 720; the first sensing electrodes 721 are disposed on the substrate 720, and electrically connected to the exposed two terminals of the bridge line 724; the second sensing electrodes 722 are disposed on the insulating layer 723, and the two adjacent two second sensing electrodes 722 can be electrically connected together directly, but not limited thereto. A passivation layer 725 may be selectively formed on the first sensing electrodes 721, the second sensing electrodes 722, the insulating layer 723 and the bridge line 724. In this embodiment, the bridge line 724 may be a single-layered bridge line e.g. a metal bridge line or a transparent conducting bridge line such as an indium tin oxide (ITO) bridge line, or a multi-layered bridge line such as a stacking structure formed by metal and transparent conducting material. The first sensing electrodes 721 and the second sensing electrodes 722 may be formed by the same transparent conducting material, and patterned by the same patterning process.

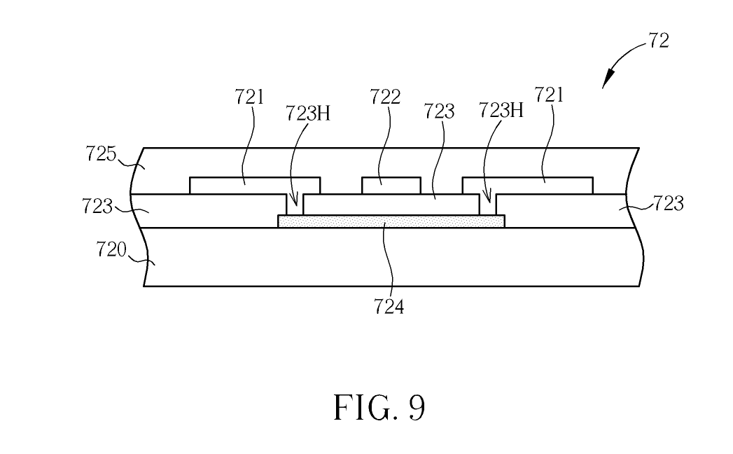

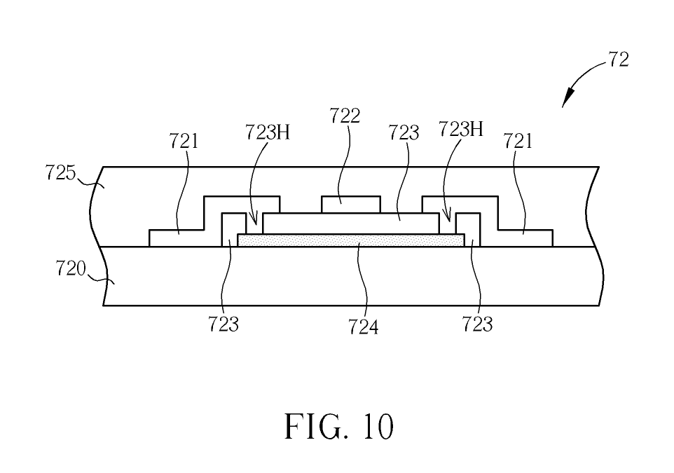

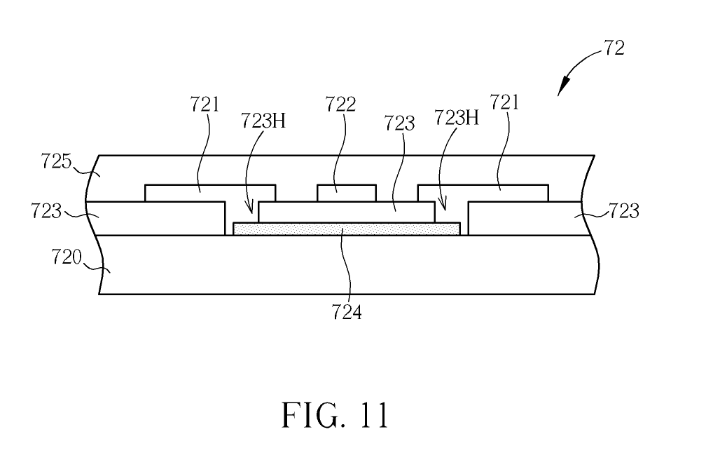

Please refer to FIG. 9-FIG. 11. FIG. 9-FIG. 11 are schematic diagrams respectively illustrating the touch device of the touch display panel according to three different variant embodiments of FIG. 8A and FIG. 8B. In these three variant embodiments, the first sensing electrode 721 is electrically connected to the bridge line 724 through the contact hole 723H of the insulating layer 723. The contact hole 723H may only expose the bridge line 724 (as shown in FIG. 9 and FIG. 10), or the contact hole 723H may expose the bridge line 724 and part of the substrate 720 (as shown in FIG. 11). In addition, the insulating layer 723 may cover the substrate 720 thoroughly (as shown in FIG. 9), or may only partially cover the substrate 720 (as shown in FIG. 10).

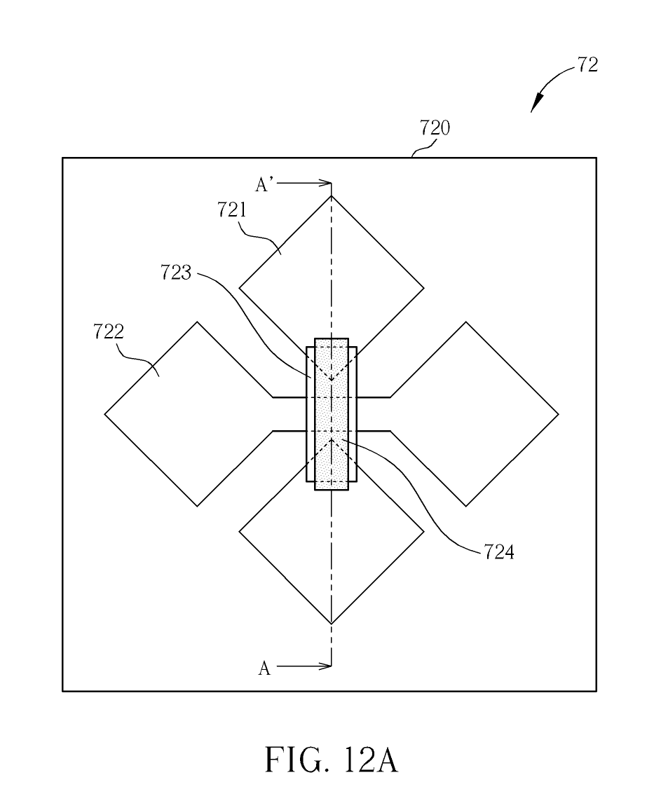

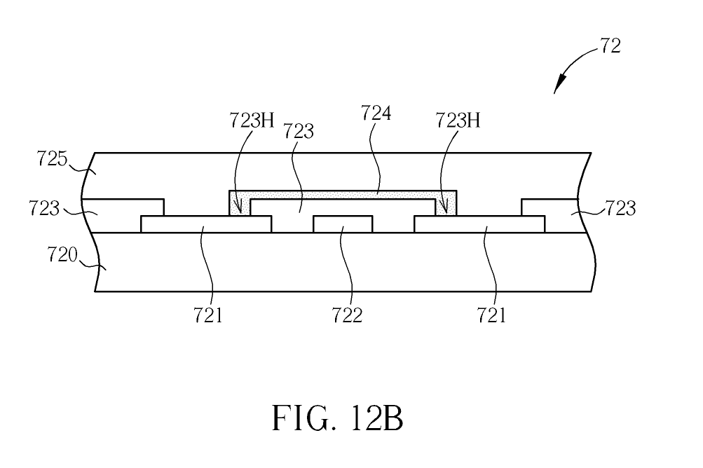

Please refer to FIG. 12A and FIG. 12B. FIG. 12A is a top view illustrating the touch device of the touch display panel according to another preferred embodiment of the present invention, and FIG. 12B is a cross-section view of the touch device of the touch display panel taken along line A-A′ of FIG. 12A. As shown in FIG. 12A and FIG. 12B, in this embodiment, the display region touch device or the hot key region touch device can be, for example, a capacitive touch device 72, which includes a substrate 720, a plurality of first sensing electrodes 721, a plurality of second sensing electrodes 722, an insulating layer 723 and a bridge line 724. The first sensing electrodes 721 and the second sensing electrodes 722 may be formed by the same transparent conducting material and disposed on the substrate 720. The insulating layer 723 covers the substrate 720, the first sensing electrodes 721 and the second sensing electrodes 722, and partially exposes the first sensing electrodes 721. The bridge line 724 is disposed on the insulating layer 723, and electrically connected to the exposed adjacent first sensing electrodes 721, and the adjacent second sensing electrodes 722 may be electrically connected directly, but not limited thereto. A passivation layer 725 may be selectively formed on the insulating layer 723 and the bridge line 724.

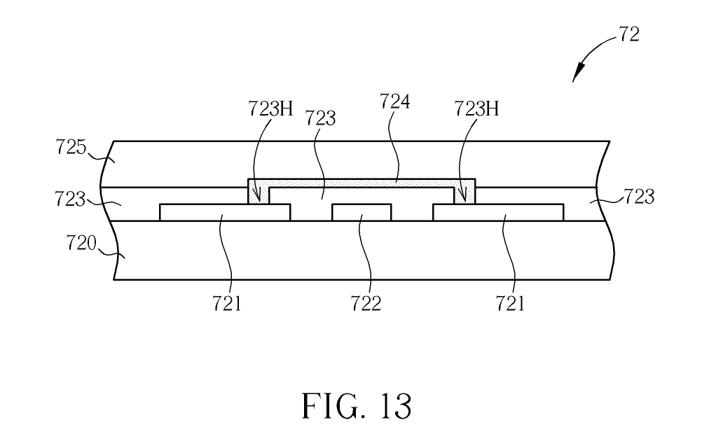

Please refer to FIG. 13. FIG. 13 is a schematic diagram illustrating the touch device of the touch display panel according to a variant embodiment of FIG. 12A and FIG. 12B. As shown in FIG. 13, the bridge line 724 is entirely filled into the contact hole 723H of the insulating layer 723 to electrically connect the first sensing electrodes 721.

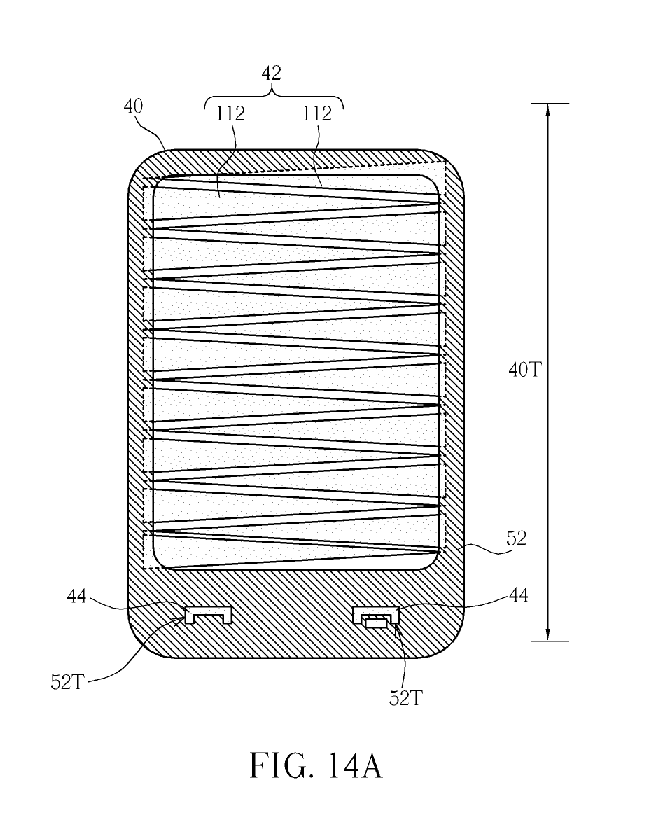

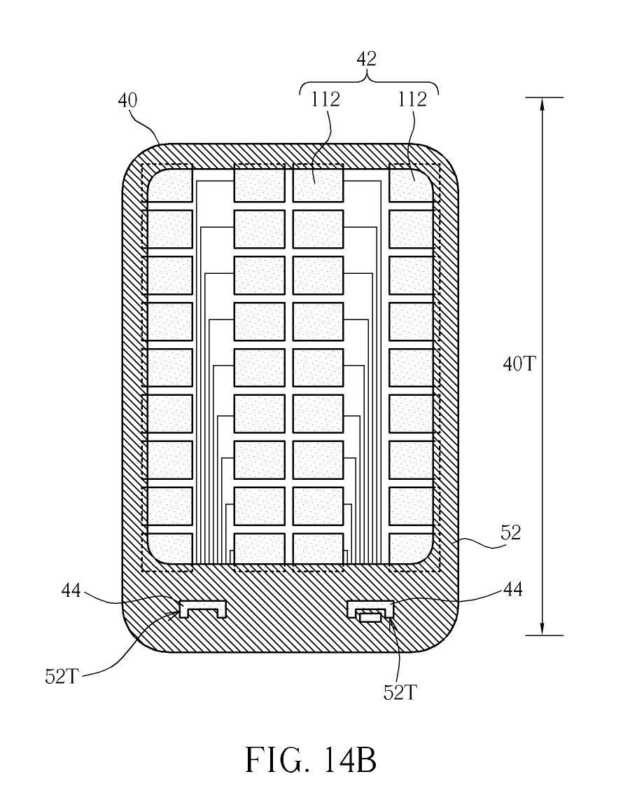

The touch device of the present invention is not limited to the above embodiments. For example, the first sensing electrodes 721 and the second sensing electrodes 722 may be formed separately by different conducting materials, i.e. the first sensing electrodes 721 and the second sensing electrodes 722 are double-layered structure. In this case, the first sensing electrodes 721 may be directly connected without requiring the bridge line 724. Also, even when the display region touch device 42 is single-layered touch device, the adjacent electrodes are not limited to be electrically connected through a bridge line, and can be electrically connected directly. Please refer to FIG. 14A. FIG. 14A is a schematic diagram illustrating a single-layered sensing electrode according to a preferred embodiment of the present invention. As shown in FIG. 14A, the display region touch device 42 includes a plurality sensing electrodes 112, and the shape of the sensing electrodes 112 is triangle. Please refer to FIG. 14B. FIG. 14B is a schematic diagram illustrating a single-layered sensing electrode according to a variant embodiment of the preferred embodiment of the present invention shown in FIG. 14A. As shown in FIG. 14B, the display region touch device 42 includes a plurality sensing electrodes 112, and the shape of the sensing electrodes 112 is rectangle. The sensing electrodes 112 can be made of the same patterned conductive layer, or different patterned conductive layers. The shape of the single-layered sensing electrode can be any geometric shapes such as square, polygon, comb-shaped, etc.

In conclusion, the touch display panel of the present invention uses touch device as the hot key, instead of conventional mechanical button. The reliability and durability of the hot key can be enhanced because no mechanical button is requited. The touch hot key also makes it possible to render a flat surface to the touch panel of electronic product, which is esthetic and durable. Furthermore, the hot key region touch device and the display region touch device can be controlled independently, and thus power consumption can be reduced. Also, he hot key region touch device and the display region touch device can be formed integrally without requiring extra process steps, and thus manufacturing cost can be reduced. Furthermore, the hot key display unit disposed in the hot key region can display predetermined or changeable hot key pattern through the transparent region of the patterned decoration layer, and thus the touch display panel can provide a user-friendly interface. The touch display panel of the present invention can be applied in various types of electronic products such as smart phone, GPS, tablet PC, PDA, laptop computer, digital camera, etc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display panel, having a display region and at least one hot key region, the touch display panel comprising:
an electroluminescent display panel comprising a plurality of display devices disposed in the display region, and a hot key display unit disposed in the hot key region;
a touch panel, disposed oppositely to the electroluminescent display panel, the touch panel comprising:
a touch plate;
a plurality of display region touch devices disposed in the display region; and
at least one hot key region touch device disposed in the hot key region, wherein the display region touch devices and the hot key region touch device are disposed on an inner surface of the touch plate facing the electroluminescent display panel; and
a patterned decoration layer, disposed on the touch plate, wherein the patterned decoration layer has at least one transparent region corresponding to the hot key region.

2. The touch display panel of claim 1, further comprising an optical film disposed on an outer surface of the touch plate, or disposed between the touch panel and the electroluminescent display panel.

3. The touch display panel of claim 2, further comprising an adhesive layer disposed between the electroluminescent display panel and the touch panel, or disposed between the optical film and the electroluminescent display panel, or between the optical film and the touch panel.

4. The touch display panel of claim 1, wherein the patterned decoration layer is disposed on an outer surface of the touch plate, or on the inner surface of the touch plate.

5. The touch display panel of claim 1, wherein the hot key display unit comprises at least one light emitting device, and the transparent region of the patterned decoration layer comprises at least one transparent pattern corresponding to the at least one light emitting device for displaying a predetermined hot key pattern.

6. The touch display panel of claim 1, wherein the hot key display unit comprises a light emitting array, and the transparent region of the patterned decoration layer comprises a window corresponding to the light emitting array for displaying a changeable hot key pattern.

7. The touch display panel of claim 1, wherein the display devices comprises active matrix display devices or passive matrix display devices.

8. The touch display panel of claim 1, wherein the display region touch devices and the at least one hot key region touch device are electrically connected to different signal lines, respectively.

9. The touch display panel of claim 1, wherein the display region touch devices and the at least one hot key region touch device share a driving chip and a flexible printed circuit board.

10. The touch display panel of claim 1, wherein the touch plate is a lid encapsulation or a cover lens, and the lid encapsulation and the cover lens comprise a glass substrate or a transparent plastic substrate.

11. The touch display panel of claim 1, wherein a material of the patterned decoration layer comprises ink, diamond-like carbon, metal, ceramics, photoresist or resin.

12. The touch display panel of claim 1, wherein the display region touch devices comprises a plurality of sensing electrodes.

13. The touch display panel of claim 12, wherein a portion of the sensing electrodes partially overlap the patterned decoration layer.

14. The touch display panel of claim 12, wherein the sensing electrodes are single-layered sensing electrodes.

15. The touch display panel of claim 12, wherein the sensing electrodes are multi-layered sensing electrodes.

16. A touch display panel, having a display region and at least one hot key region, the touch display panel comprising:
an electroluminescent display panel comprising a plurality of display devices disposed in the display region, and a hot key display unit disposed in the hot key region;
a touch panel, disposed oppositely to the electroluminescent display panel, the touch panel comprising:
a touch wire plate;
a plurality of display region touch devices disposed on the touch wire plate and in the display region; and
at least one hot key region touch device disposed on the touch wire plate and in the hot key region;
a cover lens, disposed on a side of the touch panel opposite to the electroluminescent display panel; and
a patterned decoration layer, disposed on a surface of the cover lens facing the touch panel, wherein the patterned decoration layer has at least one transparent region corresponding to the hot key region.
